(19) United States
(12) Patent Application Publication
(10) Pub. No.: US 2008/0196291 A1
(43) Pub. Date: Aug. 21, 2008

(54) Modular illuminated attractant and fishing lure

(76) Inventor: Hugh Gelber, New City, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/707,351

(22) Filed: Feb. 16, 2007

(51) Int. Cl. A01K 85/01

(52) U.S. Cl. 43/17.6

(57) ABSTRACT

Presented is a modular illuminated fishing lure having an electronics module, a bait attachment module, and a bait module. The electronics module has a light source which transmits light through fiber optic cable strands in a predetermined pattern controlled by an electronic control module. A power connection on the electronics module allows the selective connection of a power plug to close an electrical circuit, and provide power to the light sources and the electronic control module. The power plug is disposed on a retaining module so that when not connected, the power plug is held away from the power connection. The bait attachment module may have a connector allowing interchangeable bait modules.

### FIELD OF THE INVENTION

The present invention relates generally to fishing lures, and more specifically, to a modular illuminated fishing lure.

### BACKGROUND OF THE INVENTION

Anglers' use of artificial attractants and lures to engage fish, either for consumption or for sport, has been well recognized for centuries. However, as the complexity of fishing attractants and lures has increased, the associated cost has increased as well. The use of lights, sound generating devices and other electronics has recently become more prevalent in the sport fishing art.

The use of light emitting diodes (LEDs) to attract fish has recently become known in the angling arts. The relatively small size, low power consumption, and durability of LEDs make such devices ideally suited for use in the aquatic environment in which fishing lures are commonly operated. Additionally, the use of multi-colored or multiple diodes allows for various colors of light to be displayed from the fishing lure. Fiber optic strands may also be disposed in connection with one or more lights to provide a directional light source.

It is known to the angling arts to use different fishing lures based on various fishing conditions. One of the drawbacks of using electronics embedded in a fishing lure is that in the electronic portions of the fishing lure tend to be the most costly. However, these elements are the least likely to need to be varied. Furthermore, the portions of the lure, such as bait portions, which are designed to be struck by a fish may see much greater wear than non-bait portions of the lure. What is needed, and is not sufficiently addressed by the prior art, is a modular fishing lure allowing the use of interchangeable and replaceable bait portions.

Additionally, the use of lights or other electronic elements require the use of a power source, such as a battery. In order to prevent the battery from being inadvertently drained when not in use, it is known to the art to use a switch to disconnect the battery from powered electronic devices. However, the prior art fails to provide for a method for easy disconnection of a electrical circuit powering an illuminated fishing lure, where the connection is robust and positive enough to withstand being used while fishing. It would be further desirable for the electrical connection of the fishing lure to resist inadvertent connection of the electrical circuit during storage or other handling.

### SUMMARY

These and other drawbacks and disadvantages of the prior art are addressed by the present principles, which is directed to a modular illuminated attractant and fishing lure.

Presented is an apparatus for attracting and catching fish, the apparatus comprising an electronics module, a bait module, and a bait attachment module. The electronics module may be advantageously comprised of a light source, a plurality of fiber optic cable strands disposed to directionally transmit light from the light source, a power source, and an electronic control module configured to receive power from the power source and to control the illumination of the at least one light source. The electronic control module may optionally be configured to selectively illuminate the light source in a predetermined pattern.

The apparatus may further include a bait attachment module attached to the electronics module, and a bait module. The bait attachment module may further be comprised of a power plug configured to close an electrical connection between the power source and electronic control module. The bait attachment module may include a bait module receiving connector.

The electronics module further may have a battery retaining clip, and the power plug may be configured to be placed onto battery retaining clip to create an electrical connection between the battery retaining clip and the power source. The power plug may optionally be attached to the bait attachment module by a retaining module that is configured to hold the power plug safely away from the battery retaining clip to prevent accidental connection when not in use. This power plug retaining module may optionally be a coiled cable that is under tension when the power plug is connected to the battery retaining clip.

The bait module may be removably attached to the bait attachment module to allow a single electronic module and bait attachment module to be used with a plurality of interchangeable bait modules. The bait module may optionally include a bait attachment module permitting positive attachment of the bait module to the bait module receiving connector of the bait attachment module. The bait module may optionally have an artificial bait or a leader line attached to the bait attachment connector.

In an alternative embodiment, an apparatus for attracting and catching fish may comprise an electronics module configured to illuminate a light source, a bait attachment module attached to the electronics module having a bait module receiving connector, and a bait module having a bait attachment connector, where the bait attachment connector is configured to connect to the bait module receiving connector and to selectively attach the bait module to the bait attachment module.

The apparatus of claim 11, wherein the bait module receiving connector and the bait attachment connector may optionally be screw-type connectors configured to be screwed together to attach the bait attachment module to the bait module.

In another useful embodiment, an illuminated attractant and fishing lure may be comprised of an electronics module having at least one light source, a plurality of fiber optic cable strands disposed to directionally transmit light from the at least one light source, a power source, an electronic control module configured to receive power from the power source and to control the illumination of the at least one light source, and a battery retaining clip electrically connected to the electronic control module. The attractant further comprises a bait attachment module attached to the electronics module, and a bait module. The bait attachment module may have a power plug configured to connect the battery retaining clip and the power source to complete an electrical circuit between the power source and the electronic control module. The bait attachment module further includes a bait module receiving connector. The bait module may include a bait attachment connector, the bait attachment connector configured to selectively attach the bait module to the bait attachment module.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows a schematic view of a modular illuminated attractant and fishing lure according to the present principles;

FIG. 2 shows a schematic view of an alternative embodiment of a modular illuminated attractant and fishing lure according to the present principles; and

FIG. 3 shows a schematic view of a modular illuminated attractant and fishing lure with the power plug connected according to the present principles.

### DETAILED DESCRIPTION

The present principles are directed to an apparatus and method for providing a modular illuminated attractant and fishing lure.

The following description illustrates the present principles. It will thus be appreciated that those skilled in the art will be able to devise various arrangements that, although not explicitly described or shown herein, embody the present principles and are included within their spirit and scope.

All examples and conditional language recited herein are intended for pedagogical purposes to aid the reader in understanding the present principles and the concepts contributed by the inventor to furthering the art, and are to be construed as being without limitation to such specifically recited examples and conditions.

Furthermore, all statements herein reciting principles, aspects and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. It will, therefore, be appreciated by those skilled in the art that the figures presented herein represent conceptual views of illustrative machinery embodying the present principles.

In the claims hereof, any element expressed as a means for performing a specified function is intended to encompass any way of performing that function, including, for example, a combination of electrical, mechanical, hydraulic or pneumatic elements that performs that function. The present principles, as defined by such claims, reside in the fact that the functionalities provided by the various recited means are combined and brought together in the manner which the claims call for. Applicant thus regards any means that can provide those functionalities as equivalent to those shown herein.

These and other features and advantages of the present principles may be readily ascertained by one of ordinary skill in the pertinent art based on the teachings herein. It is to be understood that the teachings of the present principles may be implemented in various forms of hardware, either active or passive, and the control systems in various forms of software, hardware, manual operation, or combinations thereof.

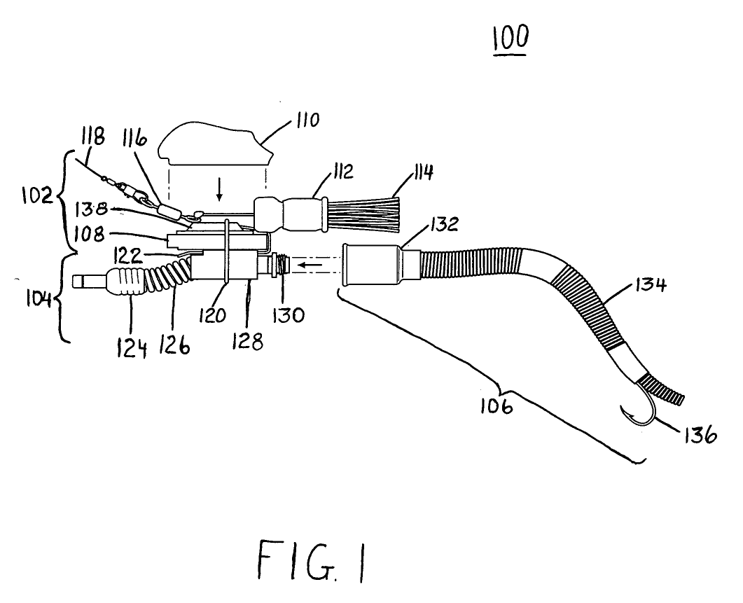

Referring now to the FIGs., where like numbers represent like elements, and in particular to FIG. 1, a schematic view of a modular illuminated attractant and fishing lure, according to the present principles, is depicted. The modular illuminated attractant and fishing lure 100 is comprised of an electronics module 102, a bait attachment module 104, and a bait module 106.

The electronics module 102 may have a light housing module 112 which provides support for one or more lighting elements. In useful embodiments, the lighting elements may be light emitting diodes (LEDs), incandescent bulbs, florescent bulbs, chemical or bio-florescent lighting elements, or the like. LEDs may be particularly advantageous because of their low power consumption, small size, low cost, and rugged construction.

The light housing module 112 may further house one or more strands of fiber optical cable 114 disposed such that light from the LEDs housed in the light housing module 112 is directed though the fiber optic cable strands 114. It is well known in the art that the use of such fiber optic strands allows for the bulk of light to be directed through the fiber optic strands in such a manner as to directionally transmit the bulk of the light parallel to the longitudinal axis of each fiber optic strand. This effect may be advantageously used in the art of fishing lure design to provide a flashing effect, where the intensity of light varies as the orientation of the fishing lure 100 is changed, or the fishing lure 100 is moved. Additionally, while the bulk of the light emitted by the LEDs is transmitted though the length of the fiber optic strands 114, some light is radiated though the sides of the fiber optic strands 114, advantageously attracting fish that may not view the fiber optic strands 114 directly from the ends.

The light emitting device may be advantageously controlled by an electronic control element 138. In one useful embodiment, the electronic control element 138 may be electrically connected to the lighting element disposed within the light housing module 112 to control the output of the lighting elements. In particularly useful embodiments, the electronic control element 138 may alternate power to lighting elements of different color, causing the final light output through the fiber optic strands to change colors. For example, red, green and blue LEDs may be disposed within the light housing module 112, and the electronic control module 138 may alternately apply power to each of the colored LEDs in sequence, resulting in a rainbow lighting effect. Alternatively, the electronic control module 138 may cause the lighting elements to blink, remain on constantly, light up in random patterns, or the like. It should be understood that the lighting elements may be usefully illuminated in any pattern, and in any combination, by the electronic control module 138 according to the present principles. It will be evident to skilled practitioners of the electronic arts to use electronic timers, microprocessors, microcontrollers, discrete circuits, analog circuits, or the like in the electronic control module. Any arrangement of devices capable of controlling a light source, known, or as yet undiscovered, is contemplated by the present principles.

The electronics module 102 may be further comprised of a power source 108 for providing electrical power to the lighting elements and other components of the electronics module 102, such as the electronic control module 138. In one useful embodiment, the power source 108 may be a battery, such as a silver oxide button-type watch battery, or the like. Alternatively, the power source may be comprised of, but is not limited to, a lithium ion battery, nickel cadmium battery, lithium polymer battery or any other suitable portable power source. The power source 108 may be electrically connected to the electronic control module 138 via an interruptible, or switchable, electrical connection. More specifically, the power source 108 may be used by the electronic control module 138 to provide power for the electronic control module 138, as well as for the lighting elements.

The electronics module 102 may also provide an attachment point 116 for a fishing line 118. In one useful embodiment, the attachment point may be a snap swivel, or the like. Alternatively, in another useful embodiment, the attachment point 116 may be a simple loop of wire allowing a snap swivel attached to the fishing line 118 to be clipped directly onto the attachment point. In yet another useful embodiment, a fishing line 118 may be attached directly to a hard attachment point, such as a wire loop, affixed to the electronics module 102.

The electronics module 102 may also be comprised of a cover 110 which may be removably disposed on the electronics module 102, and dimensioned to provide a protective shell for the electronic control module 138. In one useful embodiment, the cover 110 may be made of a material such a polymer, or the like, designed to withstand impacts and other rough handling while fishing, or while stored unused.

The electronics module 102 may also be comprised of a battery retaining clip 122. In one useful embodiment, the battery retaining clip may act as part of the power connection, allowing a user to selectively turn on the electronics module 102. In another particularly useful embodiment, the battery retaining clip 122 may be disposed on the underside of the battery, and electrically connected to the electronic control module 138 to provide an electrical connection to between the battery and the electronic control module 138. In yet another useful embodiment, the battery retaining clip 122 will also provide a location for attaching the bait attachment module 104. In such an embodiment, the battery retaining clip 122 may be fixed at one end and open at the other end, preferably the end of the battery retaining clip 122 facing the direction of fishing lure 100 travel, i.e. facing forward. Thus, when the bait attachment module 104 is attached onto the battery retaining clip 122, and the fishing lure 100 is pulled through the water in the natural direction, the frictional force of the water will tend to press the bait attachment module 104 toward the fixed end of the battery retaining clip 122, further securing the bait retaining module 104. The electronics module 102 may further include one or more retaining straps 120, which wrap around the power source 108, or are otherwise attached to the electronics module 102. The retaining straps 120 may be dimensioned to elastically fit over the bait attachment module 104 to aid in preventing the bait attachment module 104 from sliding forward, and off the battery retaining clip 122 during use or handling.

The bait attachment module 104 provides a point of attachment for the bait module 106 remote and separate from the electronics module 102. The bait attachment module 104 is made up of a retaining body 128, a power plug 124, a plug retaining module 126 and a bait module receiving connector 130.

In one particularly useful embodiment, the retaining body 128 is made of an electrically insulating material, or is sleeved in an insulating material. In a marine or aqueous environment, the electrically insulating material may advantageously be PVC, neoprene, any other weather resistant material or the like. The retaining body 128 may also advantageously attach to the battery retaining clip 122 while providing separation of the battery retaining clip 122 from the power source 108 terminal. In one useful embodiment, the attachment body 128 is sleeved in an insulating material, and the sleeve has two holes allowing the battery retaining clip 122 to pass through the sleeve of the attachment body 128. Thus, in such an embodiment, the attachment body 128 sleeve is held between the battery retaining clip 122 and the power source 108, preventing an inadvertent electrical connection between the battery retaining clip and the power source. In an alternative, yet equally useful, embodiment, the battery retaining clip 122 is not normally in contact with the power source 108, and is used as an attachment point for the attachment body 128.

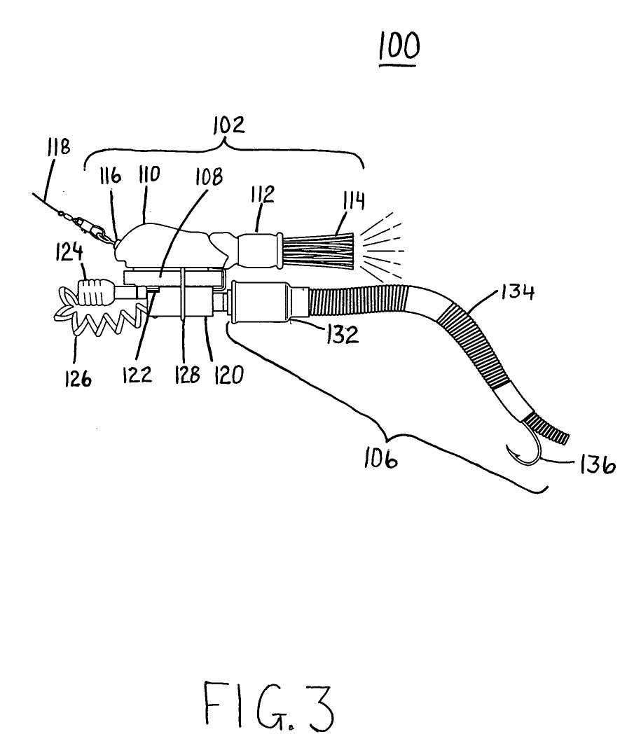

The power plug 124 may have an electrically conductive portion configured to be placed over the end of the battery retaining clip 122 which protrudes through the attachment body 128 sleeve. As shown in FIG. 3, the power plug 124 may be dimensioned such that when connected onto the battery retaining clip 122, the electrically conductive portion of the power plug 124 is in contact with both a terminal of the power source 108 and the battery retaining clip 122. Thus, the power plug may complete an electrical circuit between the battery retaining clip 122 and the power source 108, resulting in a closed circuit between the power source 108 and the electronic control module 138. This closed circuit turns on the illuminating portions of the fishing lure 100. The power plug 124 is attached to the attachment body 128 by a retaining module 126. The retaining module may be a coiled, sprung cord that advantageously holds the power plug away from the battery retaining clip 122 and the power source 108 when the power plug 124 is not attached to the battery retaining clip. In such an arrangement, the power plug may be disposed such that accidental activation of the electronics module 102 is unlikely. Alternatively, the retaining module 126 may be a spring, a torsion member, or any other element for positively holding the power plug away from the power source 108 and the battery retaining clip 122 when the power plug 124 is not intentionally connected.

According to another embodiment, the bait attachment module 104 and the electronics module 102 may be permanently affixed to each other, and the battery retaining clip 122 acts only as an electrical connection point for the power plug 124. Alternatively, the electrical connection point for connecting the power plug 124 may be located in any location that allows a user of the fishing lure 100 a convenient way to access the electrical contact elements, or to visually verify that the electrical connection has been disconnected.

The bait module receiving connector 130 allows a bait module 106 to be selectively attached to the bait attachment module 104. According to one embodiment, the bait module receiving connector 130 is a threaded module, which accepts a mating and complementarily threaded connector on the bait module 106. In another useful embodiment, the bait module receiving connector 130 may be a quick release type, an interference, or friction, type fit, or any other type of connector allowing removal and replacement of the bait module 106.

The bait module 106 may advantageously have a bait attachment connector 132 complementing the bait module receiving connector 130 of the bait attachment module 104. The bait attachment connector 132 of the bait module 106 connects an artificial bait 134, such as a plastic worm, or the like, and associated fish hook 136 to the bait attachment module 104. It should be understood that any type of artificial bait may be used in the bait module, along with any known or as yet undiscovered fish hook and fish hook arrangement. Thus, for example, the artificial bait may be, but is not limited to, artificial worms as shown in FIGS. 1 and 3, artificial crawfish, artificial fish, jigs, spoons, flies, spinners, or the like. Similarly, the number and arrangement of fish hooks 136 may be advantageously varied while still remaining within the present principles. For example, one or more single fish hooks, one or more treble hooks, or the like, may be used. These fish hooks 136 may be arranged in any rigging scheme, such as, but not limited to, a Texas rig, a Carolina rig, a wishbone rig, a paternoster rig, or the like. Furthermore, live bait may be disposed on the bait module 106. Nightcrawlers, minnows, crickets or any other live bait may be used on the fishhooks. Likewise, any non-live, non-artificial bait such as corn, stinkbait, fish eggs, bread, or the like, may be advantageously disposed on the fishing hooks, or, as a supplement to, or in conjunction with, any live or artificial bait.

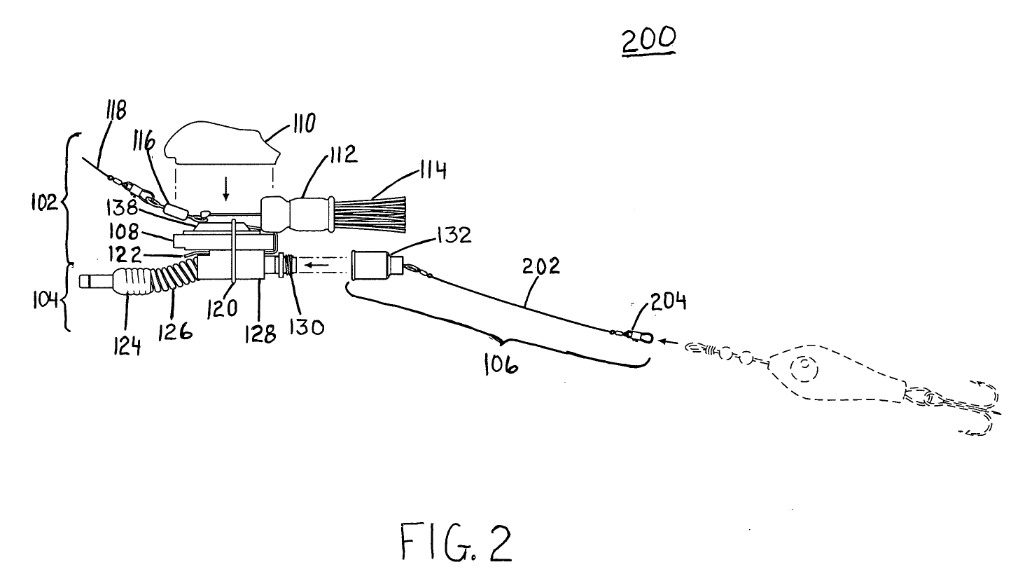

FIG. 2 is a schematic view of an alternative embodiment of a modular illuminated attractant fishing lure 200 according to the present principles. In this view, it can be seen that the bait module 106 is made up of a bait attachment connector 132 attached to a leader line 202. Such leader lines are well known to the art, and may have a snap swivel or other lure attachment connector 204 for allowing the attachment of other standard artificial lures. Thus, the bait module 106 may be removed from the bait attachment module 104 and interchanged, allowing the use of a single electronics module 102 and bait attachment module 104, with various and interchangeable bait modules 106. Furthermore, the use of a leader line bait module 106 as shown in FIG. 2 permits the connection and subsequent use of various artificial jigs and lures that may have standard attachment swivels or loops. The use of a removable bait module 106 permits an angler to easily change baits modules 106 to suit various fishing conditions. It is well known to anglers that water conditions, weather conditions, temperature, lighting, time of day, and the like, all factor into what size, color, arrangement and type of bait to use. The removable bait module 106 also allows a worn or damaged bait module to be replaced without the expense of replacing the electronics module 102 as well.

Although the illustrative embodiments have been described herein with reference to the accompanying drawings, it is to be understood that the present principles are not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. An apparatus for attracting and catching fish, the apparatus comprising:
an electronics module comprising:
at least one light source;
a plurality of fiber optic cable strands disposed to directionally transmit light from the at least one light source;
a power source; and
an electronic control module configured to receive power from the power source and to control the illumination of the at least one light source;
a bait attachment module attached to the electronics module; and
a bait module, removably attached to the bait attachment module.

2. The apparatus if claim 1, wherein the bait attachment module comprises a power plug configured to close an electrical connection between the power source and electronic control module.

3. The apparatus of claim 2, wherein the electronics module further comprises a battery retaining clip, and the power plug is configured to be placed in electrical connection with the battery retaining clip and the power source, the power plug retained in place by the battery retaining clip.

4. The apparatus of claim 3, wherein the bait attachment module further comprises a power plug retaining module configured to dispose the power plug away from the battery retaining clip when the power plug is disconnected from the battery retaining clip.

5. The apparatus of claim 4, wherein the power plug retaining module is a coiled cable configured to be under tension when the power plug is connected to the battery retaining clip, and configured to return to a neutral position, disposing the power plug away from the battery retaining clip and power source when the power plug is disconnected from the battery retaining clip.

6. The apparatus of claim 1, wherein the bait attachment module is removable from the electronics module.

7. The apparatus of claim 1, wherein the electronic control module is configured to selectively illuminate the at least one light source in a predetermined pattern.

8. The apparatus of claim 1, wherein the bait module comprises a bait attachment connector configured to positively attach to the bait module receiving connector.

9. The apparatus of claim 8, wherein the bait module further comprises an artificial bait connected to the bait attachment connector.

10. The apparatus of claim 8, wherein the bait module further comprises a leader line attached to the bait attachment connector.

11. An apparatus for attracting and catching fish, the apparatus comprising:
an electronics module configured to illuminate a light source;
a bait attachment module attached to the electronics module, comprising:
a bait module receiving connector;
a bait module comprising:
a bait attachment connector, the bait attachment connector configured to connect to the bait module receiving connector and to selectively attach the bait module to the bait attachment module.

12. The apparatus of claim 11, wherein the bait module receiving connector and the bait attachment connector are screw-type connectors, and are configured to be screwed together to attach the bait attachment module to the bait module.

13. The apparatus of claim 12, wherein the bait module further comprises an artificial bait connected to the bait attachment connector.

14. The apparatus of claim 12, wherein the bait module further comprises a leader line attached to the bait attachment connector.

15. An illuminated attractant and fishing lure, comprising
an electronics module comprising:
at least one light source;
a plurality of fiber optic cable strands disposed to directionally transmit light from the at least one light source;
a power source;
an electronic control module configured to receive power from the power source and to control the illumination of the at least one light source; and
a battery retaining clip electrically connected to the electronic control module;
a bait attachment module attached to the electronics module, comprising:
a power plug configured to be selectively placed in simultaneous connection with the battery retaining clip and the power source to complete an electrical circuit between the power source and the electronic control module;
a bait module receiving connector;
a bait module comprising:
a bait attachment connector, the bait attachment connector configured to connect to the bait module receiving connector and to selectively attach the bait module to the bait attachment module.

16. The apparatus of claim 15, wherein the bait attachment module further comprises a power plug retaining module configured to dispose the power plug away from the battery retaining clip when the power plug is disconnected from the battery retaining clip.

17. The apparatus of claim 16, wherein the power plug retaining module is a coiled cable configured to be under tension when the power plug is connected to the battery retaining clip, and configured to return to a neutral position, disposing the power plug away from the battery retaining clip and power source when the power plug is disconnected from the battery retaining clip.

18. The apparatus of claim 15, wherein the bait module receiving connector and the bait attachment connector are screw-type connectors, and are configured to be crewed together to attach the bait attachment module to the bait module.

19. The apparatus of claim 18, wherein the bait module further comprises an artificial bait connected to the bait attachment connector.

20. The apparatus of claim 18, wherein the bait module further comprises a leader line attached to the bait attachment connector.
